(19) United States
(12) Patent Application Publication
(10) Pub. No.: US 2004/0076432 A1
(43) Pub. Date: Apr. 22, 2004

(54) Nonlinear optical crystal element and coherent light generating device

(75) Inventors: Jun Sakuma, Tokyo (JP); Yuichi Asakawa, Tokyo (JP)

Correspondence Address: PEARNE & GORDON LLP, 1801 EAST 9TH STREET, SUITE 1200, CLEVELAND, OH, 44114-3108, US

(73) Assignee: Cyber Laser, Inc.

(21) Appl. No.: 10/619,302

(22) Filed: Jul. 14, 2003

(30) Foreign Application Priority Data
Jul. 15, 2002 (JP) 2002-206317

(51) Int. Cl. H04B 10/24

(52) U.S. Cl. 398/42

(57) ABSTRACT

The present invention offers a coherent light generating device with extremely little Fresnel loss. Additionally, the invention makes anti-reflection coatings on the end surfaces of a wavelength-converting medium unnecessary, while also reducing deterioration of anti-reflection coatings and wavelength-converting medium end surfaces, thereby improving the durability of the device. The invention relates to a coherent light generating device comprising an excitation beam source for generating an excitation beam polarized in a predetermined direction; a wavelength-converting medium having a first end surface and a second end surface, for receiving the excitation beam incident on the first end surface and outputting from the second end surface one or two wavelength-converted beams polarized in the same direction as the predetermined direction; and first and second mirrors provided respectively at the first end surface and the second end surface of the wavelength-converting medium, for reflecting wavelength-converted light emitted from the wavelength-converting medium and causing resonance thereof; wherein the first end surface is oriented so that the excitation beam and the wavelength-converted beam reflected by the first mirror are incident at roughly the Brewster's angle, and the polarization of the excitation beam and the wavelength-converted beam is P-polarized with respect to the first end surface; and the second end surface is oriented so that the wavelength-converted beam reflected by the second mirror is incident at roughly the Brewster's angle, and the polarization of the wavelength-converted beam is P-polairized with respect to the second end surface.

### BACKGROUND OF THE INVENTION

The present invention relates to a coherent light generating device using wavelength conversion, and particularly to a light oscillator device with substantially increased wavelength conversion efficiency due to a reduction in loss of amplified light during resonance enabling high-efficiency wavelength conversion.

The basic principle of laser oscillator devices is to illuminate solids such as ruby or gases such as carbon dioxide with an excitation beam to cause a high-energy inversion in their atoms, such that a resonator can be used to amplify the light emitted when their energy states return to their normal level, enabling the light to be extracted in the form of a phase-matched beam of a single color. Additionally, in recent years, the use of nonlinear optics to obtain outputs with a plurality of wavelengths has become common.

FIG. 1 shows the basic idea behind a laser oscillator device. For example, a lasing medium 110 such as ruby receives an excitation beam 120 from an Nd:YAG laser or the like, with light amplification being performed on the same optical axis 130 as the excitation beam 120. The coherent laser beam 140 amplified and emitted from the lasing medium 110 propagates along the optical axis, is reflected by the mirror 150 on the right side of the drawing, passes in the opposite direction through the lasing medium 110 where it is further amplified, then reaches the mirror 155 on the left side of the drawing where it is reflected back toward the lasing medium 110. The laser beam 140 which is amplified by repeated reflections through the lasing medium 110 in this way can be directed off the optical axis by a combination of a polarized beam splitter 170 and a Pockels cell 160 for selectively rotating the polarization of the laser beam according to a control voltage.

As opposed to laser oscillation belonging to linear optics wherein the incident excitation beam and the output beam are of the same wavelength, the lasing medium 110 can be replaced with a medium having a periodically poled structure which acts as a wavelength-converting medium, to perform quasi-phase matching, and to make use of the generation of second-order harmonics and optical parametric interactions to obtain laser beams of wavelengths different from the excitation beam. This is known as nonlinear optics, and the wavelength-converting medium is known as a nonlinear crystal element, these being used as means for obtaining wavelength-converted light of wavelengths which are usually difficult to obtain.

In all of the above cases, the amplification is performed by directing the excitation beam through the lasing medium and wavelength-converting medium 110 and reflecting it between the mirrors 150 and 155, which results in so-called Fresnel loss due to reflection of the excitation beam at the ends of the medium 110. While this type of loss can be reduced by providing an anti-reflection coating on the end surfaces, such treatments are expensive and result in increases in the overall cost of the coherent light generative device.

Furthermore, when generating second-order harmonics and optical parametric interactions by means of optical crystals having a periodically poled structure as described above, the crystal can be difficult to treat with an anti-reflection coating due to the fact that the crystal is tremendously thin, about 500 μm. Furthermore, since a laser beam whose diameter is made smaller to correspond to the thickness of the crystal is supplied to the end surface, the anti-reflection coating can be damaged, thus reducing performance. Furthermore, the laser beam with reduced diameter can also damage the end surface of the optical crystal itself.

Other conventional methods for reducing the Fresnel loss include that disclosed for example in JP-A H9-80496, where it is assumed that the polarization of the input beam will differ from the polarization of the output beam, the end surface on the input side of the nonlinear optical element is oriented so that the angle of incidence is roughly equal to the Brewster's angle, and the end surface on the output side is also oriented so that the angle of emission is roughly equal to the Brewster's angle. By using this method, the reflection beam can be reduced with respect to the input and output beams at the respective end surfaces, but conversely it is not possible to largely reduce the light reflected at either the input beam or the output beam at either one of the end surfaces.

### BRIEF SUMMARY OF THE INVENTION

The present invention has been made in order to overcome the above-described problems of the conventional art, and specifically has the purpose of reducing the Fresnel loss due to reflected light from an input beam or output beam, thereby to obtain a coherent light generating device with increased conversion efficiency. Furthermore, the present invention has the purpose of obtaining a laser oscillator device that does not require an anti-reflection coating, with extremely little deterioration due to use. Other objects and effects of the present invention shall become apparent through the following descriptions of means for overcoming the problems and embodiments of the present invention.

In one aspect of the present invention, a coherent light generating device comprises an excitation beam source for generating an excitation beam polarized in a predetermined direction; a wavelength-converting medium having a first end surface and a second end surface, for receiving the excitation beam incident on the first end surface and outputting from the second end surface one or two wavelength-converted beams polarized in the same direction as the predetermined direction; and first and second mirrors provided respectively at the first end surface and the second end surface of the wavelength-converting medium, for reflecting wavelength-converted light emitted from the wavelength-converting medium and causing resonance thereof; wherein the first end surface is oriented so that the excitation beam and the wavelength-converted beam reflected by the first mirror are incident at roughly the Brewster's angle, and the polarization of the excitation beam and the wavelength-converted beam is P-polarized with respect to the first end surface; and the second end surface is oriented so that the wavelength-converted beam reflected by the second mirror is incident at roughly the Brewster's angle, and the polarization of the wavelength-converted beam is P-polarized with respect to the second end surface.

According to this coherent light generating device, the excitation beam and wavelength-converted beam which constitute all of the light passing through the nonlinear optical element are always incident at the end surfaces at roughly the Brewster's angle, and such that they are P-polarized with respect to the nonlinear optical element, thus making the Fresnel loss as close to zero as possible, and consequently resulting in a higher conversion efficiency.

The nonlinear optical elements can be a wavelength-converting element that generates second-order harmonics, a sum frequency generating element or an optical parametric oscillator element.

Nonlinear optical elements are characterized in that the wavelengths of the incident excitation beam and the output wavelength-converted beam differ. Therefore, in this case, the excitation beam wavelength component and the output wavelength-converted beam wavelength component will have different refractive indices, so that the excitation beam will not be reflected on the same optical path as the wavelength-converted beam in an amplification system assuming the wavelength of the incident excitation beam, and as a result, the excitation beam reflected by the mirror will not return to the excitation beam source, thus protecting the excitation beam source.

According to another aspect of the present invention, the wavelength-converting element is an optical crystal having a periodically poled structure.

The above-described nonlinear optical element is a typical example of an element having a periodically poled structure for obtaining light of variable wavelengths by generation of second-order harmonics and parametric interactions due to quasi-phase matching. Nonlinear optical elements are crystals having a periodically poled structure, with a thickness, for example, of 0.5 mm, and a width and length of a few cm. In order to make a laser incident on the end surface thereof, the laser must be focused to a radius of about 0.5 mm or less. As a result, damage can be inflicted on anti-reflection coatings or the end surfaces of the crystals, and this damage can reduce the conversion efficiency. Therefore, the present invention functions particularly effectively against this type of nonlinear optical element.

According to a further aspect of the present invention, the first and second end surfaces of the nonlinear optical element do not have anti-reflection coatings.

With the present invention, the P-polarized excitation beam is incident at roughly the Brewster's angle on the end surface of the nonlinear optical element, thus theoretically suppressing the reflected component to roughly zero. Therefore, the anti-reflection coating can be eliminated, thus reducing production costs. Furthermore, there is no need to consider the Fresnel loss, so that a necessary output beam can be obtained by means of an excitation beam of comparatively little energy. In other words, the total amount of optical energy incident on the end surfaces of the nonlinear optical element over the process of wavelength conversion can be decreased, thus also reducing the damage to the end surfaces.

In yet another aspect, the present invention offers a method of making a P-polarized excitation beam incident on a wavelength-converting medium at roughly the Brewster's angle; and reflecting a wavelength-converted beam emitted from said wavelength-converting medium by means of a mirror so as to make it incident on the nonlinear optical element as a P-polarized beam at roughly the Brewster's angle, thereby reducing the optical loss during resonance.

With the above-described coherent light generating method, the Fresnel loss can be held theoretically to about zero, thereby increasing the conversion efficiency. Furthermore, this consequently allows the anti-reflection coatings to be removed, thus reducing costs, as well as protecting the anti-reflection film and end surfaces of the nonlinear optical element from damage, thus improving durability.

According to the above-described structure of the present invention, when compared with the conventional art where the end surface is set to the Brewster's angle with the P-polarized component and S-polarized component mixed together, Fresnel loss of the wavelength-converted light from the S-polarized light does not exist, thus improving the conversion efficiency.

Furthermore, according to the coherent light generating device and method of the present invention, the refractive index differs between the excitation beam wavelength component and the output wavelength-converted beam wavelength component, so that the excitation beam is not reflected on the same optical path as the wavelength-converted light in an amplification system assuming the wavelength of the incident excitation beam, as a result of which the excitation beam reflected by the mirrors will not return to the excitation beam source, thereby protecting the excitation beam source.

Furthermore, the anti-reflection coating can be removed from nonlinear optical elements with a periodically poled structure having an extremely thin crystal thickness, thus enabling device production costs to be reduced. Furthermore, since the loss at the anti-reflection coating and nonlinear optical element end surfaces can be reduced, deterioration of the oscillation performance can be prevented.

### BRIEF DESCRIPTION OF THE DRAWINGS

FIG. 1 is a schematic diagram showing a conventional laser oscillator device.

FIG. 2 is a schematic diagram showing a first embodiment of the present invention.

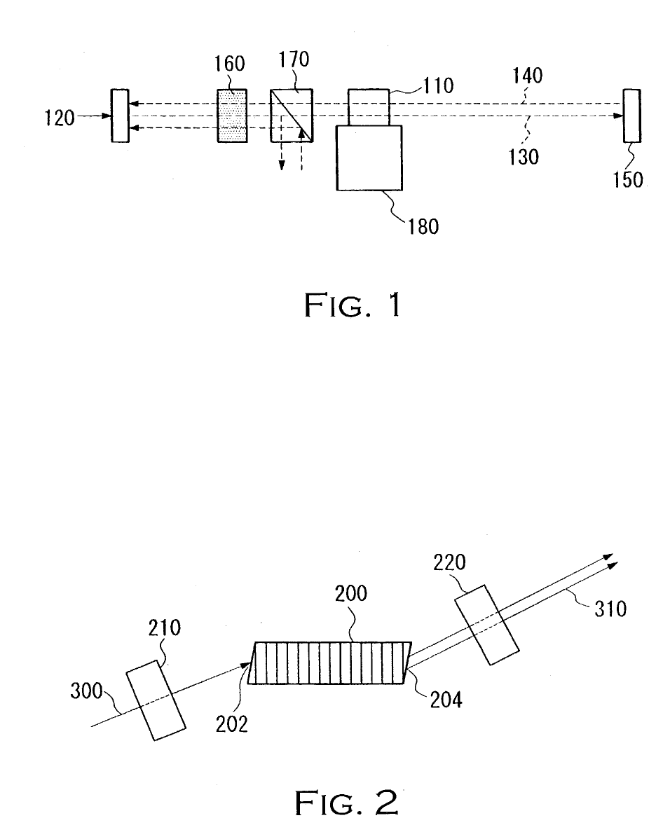

### DETAILED DESCRIPTION OF THE INVENTION

An embodiment of the present invention will now be described with reference to the drawings.

FIG. 2 is a schematic diagram showing an embodiment of the present invention. A pair of mirrors 210, 220 is respectively provided on either side of a nonlinear optical element 200 having a periodically poled structure, and an excitation beam source, not shown, is provided to the outside of the left side mirror 210 in order to supply an excitation beam.

The nonlinear optical element 200 having a periodically poled structure can, for example, be an LiNbO₃ crystal having a periodically poled structure (PPLN).

The excitation beam 300 emitted from the excitation beam source 230 passes through the left side mirror 210, reaches the first end surface 202 of the nonlinear optical element 200, and is refracted. The beam is quasi-phase matched while passing through the nonlinear optical element 200 having a periodically poled structure, thus generating second-order harmonics, and an optical parametric interaction then generates light having a plurality of wavelengths λ₂ and λ₃ different from the wavelength λ₁ of the excitation beam 300. The beam 310 generated by the nonlinear optical element 200 is reflected by the right side mirror 220, and reaches the second end surface 204 on the right side of the nonlinear optical element 200, from where it progresses into the nonlinear optical element 200.

Here, in the present invention as shown in FIG. 2, the excitation beam 300 is polarized in the plane of the page, and the angle of incidence on the first end surface 202 of the nonlinear optical element 200 is roughly equal to the Brewster's angle. Since the Brewster's angle is the angle of incidence where the reflection coefficient of the component of light polarized on the plane of incidence of the incident beam becomes roughly zero, the energy of the component of the excitation beam 300 of wavelength λ₁ polarized along the plane of incidence which is reflected by the first end surface 202 will theoretically be held to about zero. Therefore, the excitation beam 300 progresses to the nonlinear optical element 200 without suffering any Fresnel loss. The excitation beam which has propagated inside the nonlinear optical element 200 generates two components of wavelength λ₂ and λ₃ by quasi-phase matching of the periodically poled structure of the element, and these are emitted from the second end surface 204. With quasi-phase matching, the components of wavelength λ₁, λ₂ and λ₃ can all have phase matching conditions such as to be polarized in the plane of the page. For example, such phase matching conditions are described in Martin M. Fejer et al., IEEE J. Quantum Electron., vol. 28, pp. 2631-2654, 1992.

Each component λ₁, λ₂ and λ₃ emitted from the nonlinear optical element 200 is reflected by the right side mirror 220 and reenters the nonlinear optical element 200 from the right end surface 204, but the angle of incidence on the second end surface 204 is roughly equal to the Brewster's angle, and the orientation of the second end surface is such that the polarization of each of the above components is parallel to the plane of incidence. Therefore, the reflection by the second end surface 204 of the components having wavelengthsλ₁, λ₂ and λ₃ polarized in the plane of incidence is roughly zero, so that each component is incident on the nonlinear optical element 200 with no Fresnel loss.

After repeated reflections by the right and left side mirrors 210 and 220 and amplification, the excitation beam is extracted from the resonator system by the right side mirror opposite to the side from which the excitation beam entered.

Additionally, the optical, axis of the resonator system basically consisting of the right and left mirrors 210, 220 and the nonlinear optical element 200 is matched to the components of the output beam, so that an excitation beam 300 of a different wavelength will not return to absolutely the same position as the optical axis of the excitation beam generating device after being reflected by the mirror, thus not inflicting any damage on the excitation beam generating device.

What is claimed is:

1. A coherent light generating device comprising an excitation beam source for generating an excitation beam polarized in a predetermined direction; a wavelength-converting medium having a first end surface and a second end surface, for receiving said excitation beam incident on said first end surface and outputting from said second end surface one or two wavelength-converted beams polarized in the same direction as said predetermined direction; and first and second mirrors provided respectively at said first end surface and said second end surface of the wavelength-converting medium, for reflecting wavelength-converted light emitted from said wavelength-converting medium and causing resonance thereof; wherein said first end surface is oriented so that said excitation beam and the wavelength-converted beam reflected by said first mirror are incident at roughly the Brewster's angle, and the polarization of said excitation beam and said wavelength-converted beam is P-polarized with respect to said first end surface; and said second end surface is oriented so that the wavelength-converted beam reflected by said second mirror is incident at roughly the Brewster's angle, and the polarization of said wavelength-converted beam is P-polarized with respect to said second end surface.

2. A coherent light generating device in accordance with claim 1, wherein said wavelength-converting medium has a periodically poled structure.

3. A coherent light generating device in accordance with claim 1, wherein the first and second end surfaces of said wavelength-converting medium do not have an anti-reflection coating.

4. An optical parametric oscillation method comprising steps of making a P-polarized excitation beam incident on a wavelength-converting medium at roughly the Brewster's angle; reflecting a wavelength-converted beam emitted from said wavelength-converting medium by means of a mirror so as to make it incident on the nonlinear optical element as a P-polarized beam at roughly the Brewster's angle, thereby reducing the optical loss during resonance.
